(19) United States
(12) Patent Application Publication
(10) Pub. No.: US 2026/0241949 A1
(43) Pub. Date: Aug. 20, 2026

(54) COMBINING FEW-SHOT LEARNING AND META-ADAPTERS FOR PROTRUSION DETECTION UNDERSTANDING

(71) Applicant: QUALCOMM Incorporated, San Diego, CA (US)

(72) Inventors: Venkatraman Narayanan, Northville, MI (US); Varun Ravi Kumar, San Diego, CA (US); Senthil Kumar Yogamani, San Diego, CA (US)

(21) Appl. No.: 19/057,460

(22) Filed: Feb. 19, 2025

(51) Int. Cl. B60W 50/14; G01S 17/86; G01S 17/89; G06T 17/00; G06V 10/44

(52) U.S. Cl. CPC B60W 50/14; G01S 17/86; G01S 17/89; G06T 17/00; G06V 10/44; G06V 2201/07

(57) ABSTRACT

A method for protrusion detection by a vehicle assistance system includes: obtaining sensor data; generating one or more Bird's Eye View (BEV) features from the sensor data; generating semantic information from the sensor data; applying a first machine learning model to the semantic information to generate refined semantic information that incorporates protrusion information; generating, based on the one or more BEV features and the refined semantic information, a 3D scene representation of a scene surrounding a vehicle; and generating, based on the 3D scene representation, an output comprising one or more detected objects and protrusion information corresponding to the one or more detected objects.

### TECHNICAL FIELD

This disclosure relates to image processing.

### BACKGROUND

The ability to accurately detect and classify objects, especially those with anomalous characteristics, is an important component of safe and reliable vehicle assistance systems. While advancements have been made in object detection and classification, challenges remain in identifying objects with unusual or unexpected features, such as protrusions. Traditional approaches, primarily focused on collision avoidance, often rely on 3D point cloud data from LiDAR (Light Detection and Ranging) and RADAR sensors to estimate object shapes and positions. However, these approaches have several limitations. Point cloud data, while useful for overall object shape, may not capture the fine-grained details necessary to identify subtle anomalies like permanent protrusions (e.g., extended side view mirrors) or temporary protrusions (e.g., open doors of a vehicle). Point cloud data may be noisy and susceptible to occlusions, which may hinder accurate object detection and classification. Traditional approaches often struggle to model and detect anomalous objects that deviate significantly from standard object shapes.

### SUMMARY

The disclosed techniques may be utilized by an autonomous driving system and/or vehicle assistance system for 3D object detection and understanding, leveraging the power of few-shot learning and sensor fusion techniques. Traditional Machine Learning (ML) approaches typically use large amounts of labeled data to train models. In contrast, few-shot learning techniques may enable ML models to learn from a limited number of labeled examples. Few-shot learning may be especially useful in scenarios where collecting large datasets may be expensive or time-consuming. Meta-adapters are modules that may be quickly adapted to new tasks with minimal training data. By using meta-adapters in both camera and LiDAR domains, the disclosed system may learn to extract relevant features from different sensor modalities. The techniques of this disclosure may include semantic embeddings (compressed numerical representations), which may be used in this context, to represent objects and attributes of the objects, such as, but not limited to, size, shape, and location. Protrusion information may provide information about a distinct physical extension of an object that deviates from its expected geometric boundaries. A protrusion may be characterized by a localized increase in surface depth or an outward extension relative to the object's typical or expected dimensions. Computer vision systems may detect and analyze protrusions based on shape irregularities, edge discontinuities, depth variations, or occlusion patterns in images or sensor data. For example, in an automotive context, a car door when open would be a protrusion, as the car door extends outward from the main body of the vehicle, altering the usual silhouette of the vehicle. In the context of this disclosure, a protrusion may be any physical object or portion of a physical object that extends away from the normal dimensions of the object. Some protrusions may be permanent (e.g., extended side view mirrors), while other protrusions may be temporary (e.g., an open car door). By incorporating protrusion information into semantic embeddings, the disclosed system may better determine the spatial relationships between objects.

A 3D perception pipeline is a series of steps that may process sensor data to generate 3D understanding of the scene. The 3D perception pipeline may include tasks, such as, but not limited to object detection, tracking, and semantic segmentation. The disclosed system may collect multimodal data from camera and LiDAR sensors capturing various protrusions, such as, but not limited to open doors, objects on roofs, or protruding parts of vehicles. This disclosure describes techniques for using meta-adapters to extract features from both sensor modalities. The disclosed techniques may combine the extracted features with text information to create refined semantic embeddings that may include protrusion information. Textual descriptions associated with each sample, may provide semantic context about the protrusion (e.g., “car with bike rack,” “truck with ladder”). The refined semantic embeddings may be used as inputs into a 3D perception pipeline to generate object descriptions and localization outputs.

By leveraging multiple sensor modalities and incorporating protrusion information, the disclosed techniques may achieve more accurate object detection and understanding. Few-shot learning techniques may allow the disclosed system to learn from limited labeled data, making such system more practical for real-world applications. The disclosed techniques may be more robust to variations in lighting conditions, weather, and sensor noise.

In one example, a method for protrusion detection by a vehicle assistance system includes: obtaining sensor data; generating one or more Bird's Eye View (BEV) features from the sensor data; generating semantic information from the sensor data; applying a first machine learning model to the semantic information to generate refined semantic information that incorporates protrusion information; generating, based on the one or more BEV features and the refined semantic information, a 3D scene representation of a scene surrounding a vehicle; and generating, based on the 3D scene representation, an output comprising one or more detected objects and protrusion information corresponding to the one or more detected objects.

In another example, a system for protrusion detection by a vehicle assistance system includes a memory for storing sensor data; and processing circuitry in communication with the memory. The processing circuitry is configured to obtain the sensor data and generate one or more Bird's Eye View (BEV) features from the sensor data. The processing circuitry is also configured to generate semantic information from the sensor data and apply a first machine learning model to the semantic information to generate refined semantic information that incorporates protrusion information. The processing circuitry is further configured to generate, based on the one or more BEV features and the refined semantic information, a 3D scene representation of a scene surrounding a vehicle and generate, based on the 3D scene representation, an output comprising one or more detected objects and protrusion information corresponding to the one or more detected objects.

In yet another example, non-transitory computer-readable storage media having instructions encoded thereon, the instructions configured to cause processing circuitry to: obtain sensor data and generate one or more Bird's Eye View (BEV) features from the sensor data. Additionally, the instructions are configured to generate semantic information from the sensor data and apply a first machine learning model to the semantic information to generate refined semantic information that incorporates protrusion information. Furthermore, the instructions are configured to generate, based on the one or more BEV features and the refined semantic information, a 3D scene representation of a scene surrounding a vehicle and generate, based on the 3D scene representation, an output comprising one or more detected objects and protrusion information corresponding to the one or more detected objects.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example autonomous vehicle, in accordance with the techniques of this disclosure.

FIG. 2 is a block diagram illustrating an example system that may perform the techniques of this disclosure.

FIG. 3 is a block diagram illustrating a training phase of a protrusion detection framework of a vehicle assistance system, in accordance with the techniques of this disclosure.

FIG. 4 is a block diagram illustrating an inference phase of the protrusion detection framework of the vehicle assistance system, in accordance with the techniques of this disclosure.

FIG. 5 illustrates results of the inference performed by the protrusion detection framework, in accordance with the techniques of this disclosure.

FIG. 6 is a flowchart illustrating an example method for protrusion detection by a vehicle assistance system, in accordance with the techniques of this disclosure.

### DETAILED DESCRIPTION

The ability to accurately detect and classify objects, especially objects with anomalous characteristics, may be important for the safety and reliability of vehicle assistance systems. While progress has been made in object detection using LiDAR and RADAR sensor data, current approaches often fall short when it comes to identifying and interpreting anomalies, such as, but not limited to, protrusions. Traditional approaches of a vehicle assistance system, such as an ADAS (Advanced Driver Assistance System), predominantly focus on 3D occupancy from point cloud data, configured to create a detailed 3D map of the environment. This focus on 3D occupancy may be well-suited for tasks like collision avoidance, where the primary concern may be the physical presence of objects. However, the focus on 3D occupancy may have several limitations when dealing with anomalous objects. The traditional approaches used in vehicle assistance systems often lack a deep semantic understanding of the detected objects.

An Advanced Driver Assistance System (ADAS) is one type of vehicle assistance system. The ADAS is a collection of technologies or systems that may be integrated into a vehicle to enhance safety and improve driving experiences. These systems may use sensors, cameras, radar, LiDAR, and software to monitor the surroundings of a vehicle, analyze driving conditions, and either warn the driver of potential hazards or take partial or full control of the vehicle to prevent accidents. Examples of ADAS technologies may include, but are not limited to: Adaptive Cruise Control (ACC), Lane Departure Warning (LDW) and Lane Keeping Assist (LKA), Automatic Emergency Braking (AEB), blind spot detection, traffic sign recognition, parking assistance, and driving monitoring systems. The ACC may be configured to automatically adjust the vehicle's speed to maintain a safe distance from the vehicle ahead. The LDW and LKA may be configured to alert the driver when the vehicle unintentionally drifts out of its lane or actively steers the vehicle back into the lane. The AEB may be configured to detect potential collisions and to apply brakes to avoid or reduce the impact. The blind spot detection system may be configured to warn drivers of vehicles or objects in their blind spots. The traffic sign recognition system may be configured to identify and display traffic signs, such as speed limits or stop signs, to the driver. The parking assistance system may use sensors and cameras to assist with parking, sometimes automating the process. The driver monitoring system may be configured to detect driver fatigue or distraction and may issue alerts or may take corrective actions.

Some example computer vision systems may identify the presence of an object, but these systems may struggle to recognize subtle details like protrusions that could pose significant risks. In other words, point cloud data may be noisy, especially in challenging environmental conditions like fog, rain, or low light. Additionally, occlusions from other objects may hinder the accurate detection of anomalous features. For example, anomalous objects may have complex shapes that may not be easily represented by simple geometric primitives. Difficulty in modeling complex shapes may make it difficult for traditional computer vision systems to accurately detect and classify anomalous objects.

In the context of autonomous driving and computer vision, the accurate detection and interpretation of protrusions remain challenging. Existing approaches often fall short in capturing the dynamic nature and contextual implications of these objects. Many existing approaches focus solely on the 3D geometry of protrusions, neglecting semantic meaning of protrusions. Protrusions are often dynamic, changing their position and orientation over time. Existing approaches may struggle to track these changes, leading to potential misinterpretations.

It should be noted that real-world environments surrounding a vehicle assistance system may be noisy, and protrusions may be partially occluded by other objects. Noise and occlusions may challenge the vehicle assistance system to accurately detect and classify protrusions. Understanding the scene associated with a particular protrusion may be valuable for the vehicle assistance system. The broader traffic scenario may influence the significance of a protrusion. For example, a protruding object in a crowded parking lot may pose less risk than one on a busy highway.

As noted above, different types of protrusions may require distinct responses from the vehicle assistance system. For instance, a parked vehicle with an open door may necessitate a simple lane change. Understanding the nature of a protrusion may help assess potential risks of the protrusion. A small object on the road may be safely avoided, while a large, stationary object could pose a serious threat to the vehicle assistance system.

Meta-adapters are modules that may be quickly adapted to new tasks with minimal training data. By using meta-adapters in both camera and LiDAR domains, the disclosed system may learn to extract relevant features from different sensor modalities. The techniques of this disclosure may include semantic embeddings (compressed numerical representations), which may be used in this context, to represent objects and attributes of the objects, such as, but not limited to, size, shape, and location. Protrusion information may provide information about how much an object extends beyond surrounding environment. By incorporating protrusion information into semantic embeddings, the disclosed system may better determine the spatial relationships between objects.

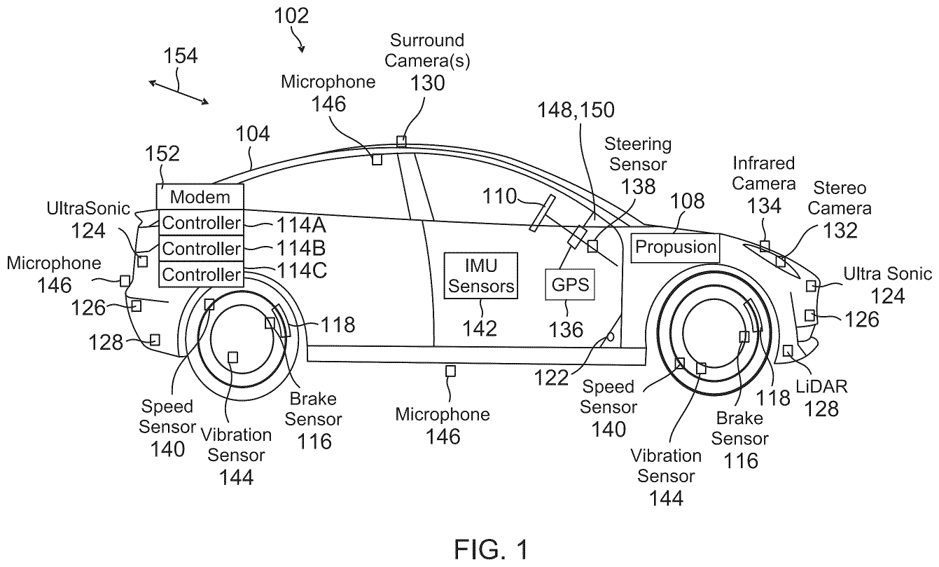

FIG. 1 shows an example vehicle 102. Vehicle 102 in the example shown may comprise a passenger vehicle such as a car or truck that can accommodate a human driver and/or human passengers. In an aspect, vehicle 102 may comprise an autonomous vehicle, semi-autonomous vehicle and/or vehicle with an ADAS system. Vehicle 102 may include a vehicle body 104 suspended on a chassis, in this example comprised of four wheels and associated axles. A propulsion system 108 such as an internal combustion engine, hybrid electric power plant, or even all-electric engine may be connected to drive some or all of the wheels via a drive train, which may include a transmission (not shown). A steering wheel 110 may be used to steer some or all of the wheels to direct vehicle 102 along a desired path when the propulsion system 108 is operating and engaged to propel the vehicle 102. Steering wheel 110 or the like may be optional for Level 5 implementations. One or more controllers 114A-114C (a controller 114) may provide autonomous capabilities in response to signals continuously provided in real-time from an array of sensors, as described more fully below.

Each controller 114 may be essentially one or more onboard computers that may be configured to perform deep learning and/or artificial intelligence functionality and output autonomous operation commands to self-drive vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide artificial intelligence functionality for in-camera sensors, and controller 114D (not shown) may provide infotainment functionality and provide additional redundancy for emergency situations.

Controller 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”)—a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine RPM, button positions, and other vehicle status indicators. The functional safety level for a CAN bus interface is typically Automotive Safety Integrity Level (ASIL) B. Other protocols may be used for communicating within a vehicle, including FlexRay and Ethernet.

In an aspect, an actuation controller may be obtained with dedicated hardware and software, allowing control of throttle, brake, steering, and shifting. The hardware may provide a bridge between the vehicle's CAN bus and the controller 114, forwarding vehicle data to controller 114 including the turn signal, wheel speed, acceleration, pitch, roll, yaw, GPS data, tire pressure, fuel level, sonar, brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs including, for example: one or more ultrasonic sensors 124, one or more RADAR sensors 126, one or more LiDAR sensors 128, one or more surround view cameras 130 (typically such cameras are located at various places on vehicle body 104 to image areas all around the vehicle body), one or more stereo cameras 132 (in an aspect, at least one such stereo camera may face forward to provide object recognition in the vehicle path), one or more infrared cameras 134, GPS unit 136 that provides location coordinates, a steering sensor 138 that detects the steering angle, speed sensors 140 (one for each of the wheels), an inertial sensor or inertial measurement unit (“IMU”) 142 that monitors movement of vehicle body 104 (this sensor can be for example an accelerometer(s) and/or a gyro-sensor(s) and/or a magnetic compass(es)), tire vibration sensors 144, and microphones 146 placed around and inside the vehicle. Other sensors may be used, as is known to persons of ordinary skill in the art.

Controller 114 may also receive inputs from an instrument cluster 148 and may provide human-perceptible outputs to a human operator via human-machine interface (“HMI”) display(s) 150, an audible annunciator, a loudspeaker and/or other means. In addition to traditional information such as velocity, time, and other well-known information, HMI display 150 may provide the vehicle occupants with information regarding maps and vehicle's location, the location of other vehicles (including an occupancy grid) and even the Controller's identification of objects and status. For example, HMI display 150 may alert the passenger when the controller has identified the presence of a stop sign, caution sign, or changing traffic light and is taking appropriate action, giving the vehicle occupants peace of mind that the controller 114 is functioning as intended.

In an aspect, instrument cluster 148 may include a separate controller/processor configured to perform deep learning and artificial intelligence functionality.

Vehicle 102 may collect data that is preferably used to help train and refine the neural networks used for autonomous driving. The vehicle 102 may include modem 152, preferably a system-on-a-chip that provides modulation and demodulation functionality and allows the controller 114 to communicate over the wireless network 154. Modem 152 may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: LTE, WCDMA, UMTS, GSM, CDMA2000, or other known and widely used wireless protocols.

Compared to sonar and RADAR sensors 126, cameras 130-134 may generate a richer set of features at a fraction of the cost. Thus, vehicle 102 may include a plurality of cameras 130-134, capturing images around the periphery of the vehicle 102. Camera type and lens selection depends on the nature and type of function. The vehicle 102 may have a mix of camera types and lenses to provide complete coverage around the vehicle 102. All camera locations on the vehicle 102 may support interfaces such as Gigabit Multimedia Serial link (GMSL) and Gigabit Ethernet.

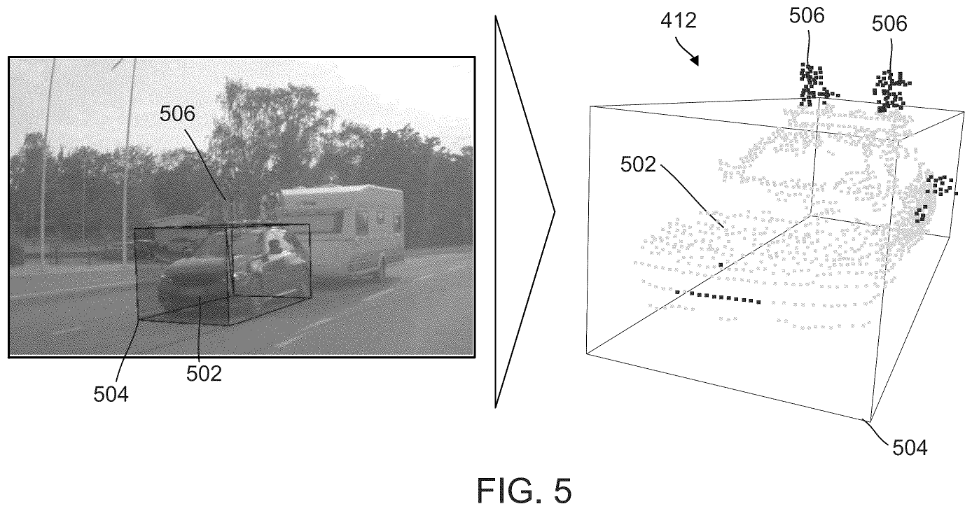

In an aspect, a controller 114 may be configured to obtain sensor data. In some examples, the sensor data may include multimodal sensor data and controller 114 may obtain the multimodal sensor data from a plurality of sensors of vehicle 102. For example, the camera pictures (e.g. a pictures shown in FIG. 5) and LiDAR data may provide a comprehensive view of the environment surrounding a vehicle assistance system, including, but not limited to, roads, buildings, and other objects. Next, controller 114 may generate one or more Bird's Eye View (BEV) features from the sensor data. The BEV features may represent the scene from a top-down perspective, like a map. BEV features represent a common and useful representation for tasks like object detection and path planning. In some examples, controller 114 may extract the BEV features from the multimodal sensor data. In an aspect, LiDAR BEV features may comprise BEV features extracted from the LiDAR point cloud data and transformed into a BEV representation. LiDAR BEV features may provide accurate distance and shape information. Camera BEV features may comprise BEV features extracted from the camera image data and also transformed into a BEV representation. Camera BEV features may include, but are not limited to, identifying objects (vehicles, pedestrians, etc.) and locations of the objects in the BEV. Controller 114 may then generate semantic information from the sensor data. In some examples, the semantic information may include one or more semantic embeddings extracted from the multimodal sensor data. The semantic embeddings (compressed numerical representations) may go beyond just identifying what objects are present and may capture meaning or context. For example, a semantic embedding may not just represent “vehicle” but also represent “vehicle parked on the side of the road” or “vehicle approaching intersection.” This richer information representation may be important for complex scene understanding. In an aspect, controller 114 may apply a first machine learning model to the semantic information to generate refined semantic information that incorporates protrusion information. Next, controller 114 may generate, based on the one or more BEV features and the refined semantic information, a 3D scene representation of a scene surrounding vehicle 102. In some examples, controller 114 may generate the 3D scene representation by concatenating the one or more BEV features and one or more refined semantic embeddings. In accordance with the techniques of the present disclosure, controller 114 may also generate, based on the 3D scene representation, an output comprising one or more detected objects and protrusion information corresponding to the one or more detected objects.

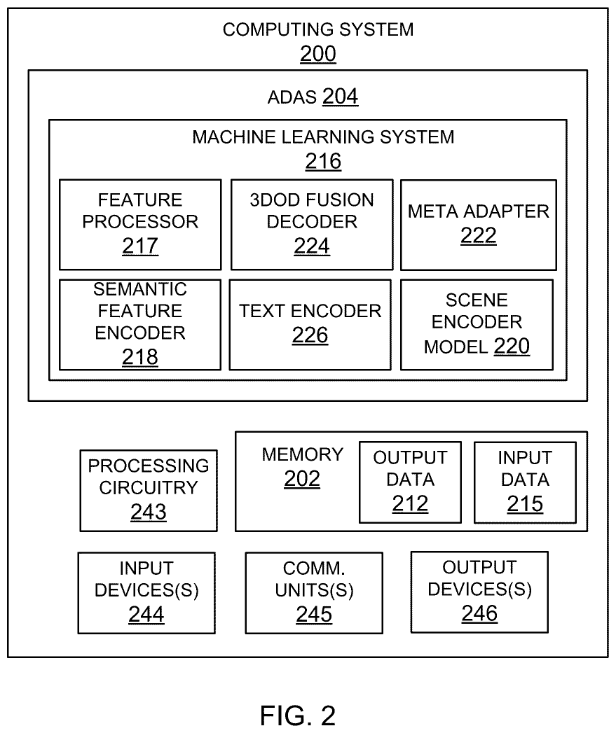

FIG. 2 is a block diagram illustrating an example computing system 200. As shown, computing system 200 comprises processing circuitry 243 and memory 202 for executing Machine Learning (ML) system 216 of ADAS 204, including one or more feature processors 217, one or more semantic feature encoders 218, one or more scene encoders 220, one or more meta-adapters 222, a 3DOD fusion decoder 224 and a text encoder 226 which may represent an example instance of any controller 114 described in this disclosure, such as controller 114 of FIG. 1. ADAS 204 may comprise an autonomous driving system and/or any other vehicle assistance system. ML system 216 may comprise various types of neural networks, such as, but not limited to, recursive neural networks (RNNs), convolutional neural networks (CNNs), and deep neural networks (DNNs). For example, ML system 216 may also include an object detection model not shown in FIG. 2.

Computing system 200 may also be implemented as any suitable external computing system accessible by controller 114, such as one or more server computers, workstations, laptops, mainframes, cloud computing systems, High-Performance Computing (HPC) systems (i.e., supercomputing) and/or other computing systems that may be capable of performing operations and/or functions described in accordance with one or more aspects of the present disclosure.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules or units described in accordance with one or more aspects of this disclosure.

Processing circuitry 243 and memory 202 may provide an operating environment or platform for one or more modules or units (e.g., feature processor 217, semantic feature encoder 218, scene encoder 220, meta-adapter 222, 3DOD fusion decoder 224, and text encoder 226), which may be implemented as software, but may in some examples include any combination of hardware, firmware, and software. Processing circuitry 243 may execute instructions and the one or more storage devices, e.g., memory 202, may store instructions and/or data of one or more modules or units. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute ADAS 204 using virtualization modules, such as a virtual machine or container executing on underlying hardware. One or more of such modules may execute as one or more services of an operating system or computing platform. Aspects of ADAS 204 may execute as one or more executable programs at an application layer of a computing platform.

One or more input devices 244 of computing system 200 may generate, receive, or process input. Such input may include input from a video camera, sensor, keyboard, pointing device, voice responsive system, biometric detection/response system, button, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 2, 3DOD fusion decoder 224 may generate output data 212. Input data 215 and output data 212 may contain various types of information. For example, multimodal input data 215 may include, but is not limited to, camera image data, LiDAR point cloud data, GPS/GNSS coordinates, and so on. Output data 212 may include the 3D scene understanding data including protrusion information and the like.

As the distance from the vehicle increases, the density of point cloud data may diminish. Such sparsity may create difficulties to accurately detect and classify protrusions at longer ranges. The sparsity may lead to false positives (misidentifying noise as protrusions) and false negatives (missing actual protrusions). One of the challenges in developing robust models for protrusion detection in vehicle assistance system may be the scarcity of relevant data. The scarcity limitation stems from the infrequent occurrence of protrusions in real-world driving scenarios. Most driving scenarios may involve standard traffic conditions without any anomalies. This may lead to a significant imbalance between the majority class (no protrusions) and the minority class (protrusions). Capturing data for specific scenarios involving protrusions may require careful planning and execution. Collecting data in real-world scenarios with rare events may pose challenges, particularly when such collection may involve potentially dangerous situations. For example, annotating protrusions (i.e., open doors) may require precise labeling of their 3D geometry, semantic class, and potential impact on driving safety. The manual annotation process may be time-consuming and labor-intensive.

The proposed ML system 216 may be configured to improve the detection and understanding of protrusions in autonomous driving scenarios by combining vision and language information. Meta-adapters 222 may be modules that may rapidly adapt to new tasks with limited data. Meta-adapters 222 may be used to fine-tune semantic feature encoders 218, e.g., the semantic camera feature encoder 218A and the semantic LiDAR feature encoder 218B. By incorporating textual descriptions 318 of protrusions (e.g., “car with a bike rack”), the meta-adapters 222 may refine the semantic embeddings 314A and 314B extracted from the camera and LiDAR data, respectively. Such refinement may allow meta-adapters 222 to focus on the relevant semantic information for protrusion detection. The refined semantic embeddings 316A and 316B may be integrated into an intrusion detection pipeline, which may generate accurate and detailed descriptions and localizations of objects in the scene. The pipeline may be designed to specifically capture and represent information about protrusions, such as shape, size, and orientation of the detected protrusion. By combining information from camera, LiDAR, and text modalities, the meta-adapters 222 may leverage the strengths of each modality to improve the overall performance. Camera image data 310 may provide rich visual information, LiDAR point cloud data 308 may offer precise 3D geometry, and text data (e.g., textual descriptions 318) may provide semantic context. By fusing these modalities, the ML system 216 may achieve a more accurate and robust understanding of the scene.

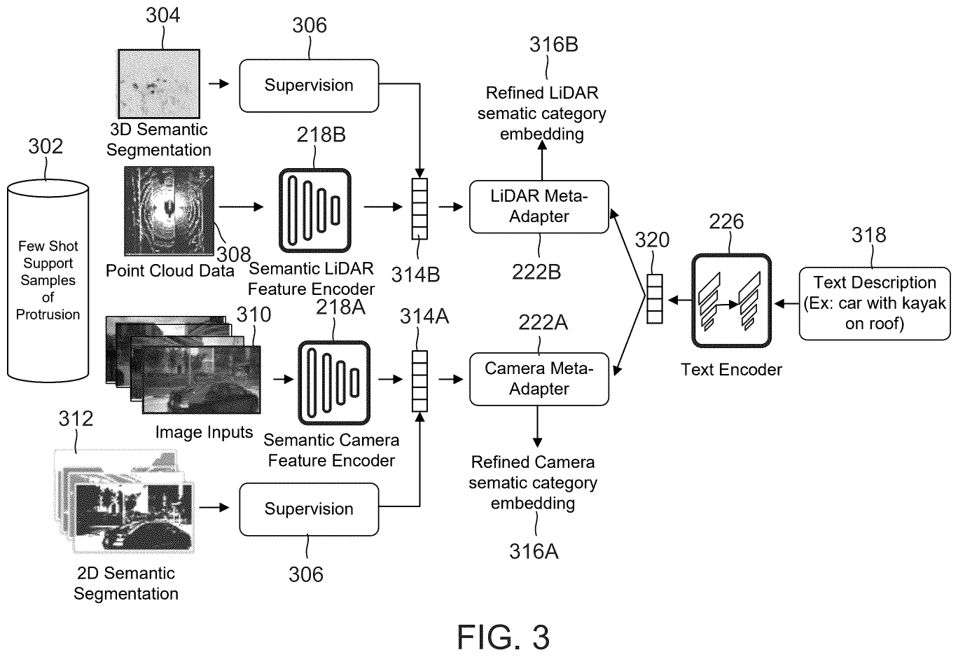

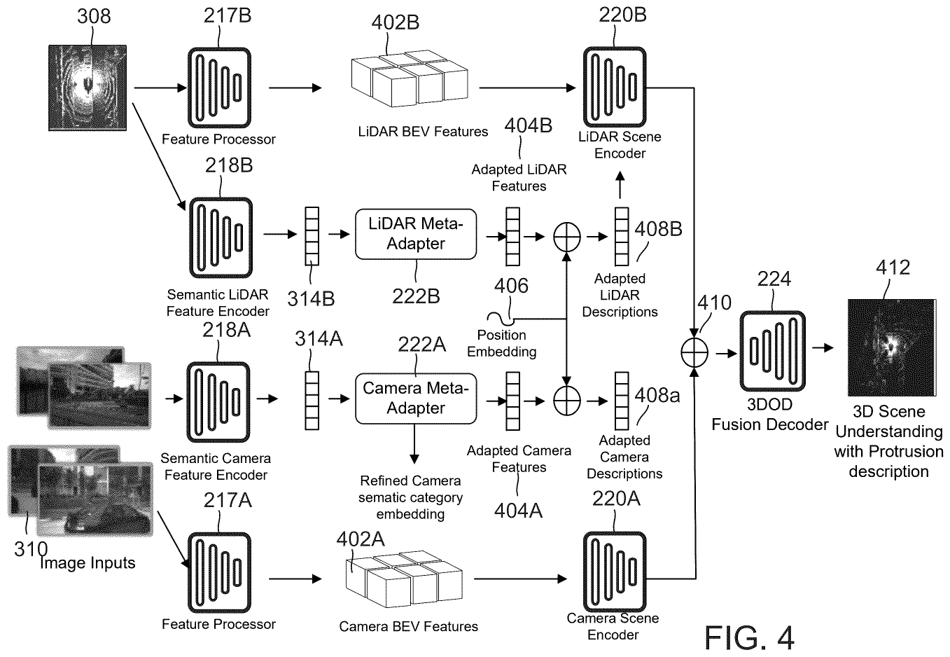

The refined semantic embeddings 316A and 316B described in greater detail below may enable the ML system 216 to accurately identify and classify protrusions, even in challenging scenarios. The protrusion detection framework illustrated in FIGS. 3 and 4 may provide a detailed understanding of the scene, including, but not limited to, the location, orientation, and semantic category of objects. Advantageously, the few-shot learning techniques may allow the meta-adapters 222A and 222B to adapt to new, unseen protrusion types with minimal additional training data.

Few-shot learning is a machine learning technique that may allow meta-adapters 222A and 222B to learn new concepts from a limited number of examples. This is in contrast to traditional machine learning, which may often require large amounts of data to train effectively. Few-shot learning technique may offer a solution to this problem by enabling meta-adapters 222A and 222B to learn from a small number of labeled examples. In the case of protrusion detection, this means training meta-adapters 222A and 222B on a limited set of data that includes, for example, support samples 302 shown in FIG. 3. For example, support samples 302 may be a small number of labeled examples of various protrusions, including camera and LiDAR data, and corresponding textual descriptions 318.

Camera image data 310 and LiDAR point cloud data 308 may be processed to extract relevant features (e.g., shape, color, distance). The textual descriptions 318 associated with the support samples 302 may be processed during the training phase shown in FIG. 3 to extract semantic information about the protrusions.

This textual information may then be integrated with the visual features to provide a richer representation of the protrusions.

The meta-adapters 222 may be trained on the support samples 302 to learn to associate the visual and textual features with the corresponding protrusion class. This training process illustrated in FIG. 3 may enable meta-adapters 222A and 222B to learn generalizable features that may be applied to new, unseen protrusions. The trained meta-adapters 222A and 222B may be used to classify the query samples. The meta-adapters 222A and 222B may extract features from the query samples and may compare them to the learned representations from the support samples 302. In an aspect, based on this comparison, meta-adapters 222A and 222B may assign a class label to the query sample. Using few-shot learning for protrusion detection, fewer labeled examples may be needed to train meta-adapters 222A and 222B. Meta-adapters 222A and 222B may learn to recognize new types of protrusions that were not explicitly seen during training.

Generally, semantic feature extraction is a technique that may be used to extract high-level information from raw data, such as, but not limited to, images or point clouds. In the context of autonomous driving, in one example, semantic feature extraction may involve identifying and classifying objects and scenes within the environment. Advantageously, semantic camera feature encoder 218A may be trained on a large dataset of camera image data 310, typically labeled with semantic segmentation annotations 312. This process may teach the semantic camera feature encoder 218A to recognize objects like cars, pedestrians, and road lanes.

Semantic LiDAR feature encoder 218B also shown in FIG. 3 may be similarly trained on a large dataset of point clouds (LiDAR point cloud data 308), labeled with semantic segmentation annotations 304. In the context of 3D object detection, this training may enable semantic LiDAR feature encoder 218B to identify objects and surfaces based on their 3D structure. In an aspect, once the feature encoders are pretrained, the semantic camera feature encoder 218A and semantic LiDAR feature encoder 218B may be further fine-tuned on a dataset that includes semantic labels for protrusions.

Camera and LiDAR feature processors 217 may generate features from their respective input data. In some examples, feature processor(s) 217 may be configured to extract features from corresponding sensor modalities. Extracting features from different sensor modalities may involve gathering data from various types of sensors and then identifying and isolating the most relevant and informative aspects of that data. Raw data from sensors is often high-dimensional, noisy, and may contain redundant information. Feature extraction may reduce the dimensionality of the data while preserving the most important information. In some examples, feature processor 217 may be implemented using an autoencoder. Autoencoders are neural networks that may be trained to reconstruct the input. The bottleneck layer of the autoencoder may learn a compressed representation of the data, which may be used as a feature vector. Autoencoders can be used for dimensionality reduction and feature extraction. Text encoder 226 may processes the textual descriptions 318, such as, but not limited to, “car with kayak on roof,” into a sequence of textual description embeddings 320, as shown in FIG. 3.

In an aspect, scene encoder 220 may comprise a neural network model that may be used by ML system 216 to process and understand images or videos. In an aspect, scene encoder 220 may be trained to convert visual input into a compressed numerical representation, or “embedding,” that captures the essential semantic information of the scene.

The 3DOD fusion decoder 224 may be configured to extract 3D scene understanding output, such as, but not limited to, object locations, dimensions, and semantic labels. In an aspect, the 3DOD fusion decoder 224 may be specifically designed to extract information about object protrusions in the 3D scene.

FIG. 3 is a block diagram illustrating a training phase of a protrusion detection framework of a vehicle assistance system, in accordance with the techniques of this disclosure. This additional training may help the meta-adapters 222 to focus on extracting features that are specifically relevant to protrusion detection. For example, the camera meta-adapter 222A may learn to pay more attention to the edges of objects and the presence of unusual shapes, while the LiDAR meta-adapter 222B may focus on height differences and anomalous point cloud densities.

As explained earlier, semantic features may provide a richer understanding of the scene, beyond just the raw pixel or point cloud data. By understanding the semantic context of objects and their relationships, ML system 216 may better identify and classify protrusions.

Meta-adapters are a technique used to improve the performance of few-shot learning models. Meta-adapters 222A and 222B may work by adaptively integrating information from different sources, such as camera and LiDAR data, respectively, and textual descriptions 318. For example, the semantic camera feature encoder 218A and semantic LiDAR feature encoder 218B may extract semantic embeddings 314A and 314B from the input data 308-310. The meta-adapters 222A and 222B may take these semantic embeddings 314A and 314B and the textual description embeddings 320 extracted from the textual descriptions 318 as input. In an aspect, the meta-adapters 222A and 222B may refine the semantic embeddings 314A and 314B by incorporating the textual description embeddings 320 from the textual descriptions 318. In an aspect, the refinement may help the ML system 216 to focus on the most relevant aspects of the data, such as, but not limited to, object protrusions.

In an example, each meta-adapter 222 may be a neural network module designed to integrate information from multiple modalities (e.g., camera and LiDAR) and textual descriptions to improve the performance of few-shot learning models. Meta-adapters 222 may be particularly useful in scenarios where only limited labeled data (e.g., few shot support samples 302) is available.

Camera and LiDAR feature processors 217 may generate (e.g., extract) features from their respective input data. Text encoder 226 may processes the textual descriptions 318, such as, but not limited to, “car with kayak on roof,” into a sequence of textual description embeddings 320, as shown in FIG. 3.

As described below, each meta-adapter 222 may have gated-multi-head attention mechanism. The gated-multi-head attention mechanism may be a specialized attention mechanism that may allow meta-adapters 222 to focus on the most relevant information from the camera/LiDAR semantic embeddings 314 and textual descriptions 318. In certain operations, the meta-adapters 222 may use MLP layers for the query and key components of the attention mechanism.

In some cases, MLP layers may avoid unnecessary transformations of the value vectors. Advantageously, by keeping the values unchanged, meta adapters 222 may directly leverage the rich information contained in the original camera/LiDAR and textual features.

As noted above, the attention mechanism may allow meta-adapters 222 to weigh the importance of different parts of the input data. By focusing on the most relevant information, the meta-adapters 222 may refine the semantic embeddings 314, leading to improved performance on few-shot learning tasks.

In an aspect, using MLP layers for query and key may be computationally efficient, as MLP layers may avoid complex transformations of the value vectors. For example, by keeping the values unchanged, meta-adapters 222 may directly leverage the rich information contained in the original features. The attention mechanism, combined with the MLP layers, may allow meta-adapters 222 to effectively integrate information from different modalities, leading to improved performance. In addition, the meta-adapters 222 may enable ML system 216 to learn from a small number of examples and generalize to new, unseen data. By combining information from multiple modalities, the meta-adapters 222 may create more robust and informative feature representations.

In other words, few-shot learning refers to the ability of meta-adapters 222 to recognize or classify objects meta-adapters 222 have never seen during training. In the context of protrusion detection, this means meta-adapters 222 may identify new types of protrusions that were not included in the training data, solely based on textual descriptions 318 of the protrusions. Meta-adapters 222 may rely on textual description embeddings 320 to understand the meaning of textual descriptions 318.

The attention mechanism may allow meta-adapters 222 to focus on the most relevant parts of the input data shown in FIG. 3, including, but not limited to, the textual descriptions 318. The attention mechanism may help meta-adapters 222 to identify the key features of a new protrusion, even if meta-adapters 222 have never seen the protrusion before. The textual description embedding 320 may serve as the query, while the semantic embeddings 314 from the semantic camera feature encoder 218A and semantic LiDAR feature encoder 218B may act as both keys and values.

In an example, the attention mechanism of meta-adapters 222 may calculate the similarity between the query and key embeddings, and then may use this similarity to weight the value embeddings. As a non-limiting example, the attention mechanism may be designed to focus on the relevant information. In other words, the attention mechanism may naturally downweight outlier samples that are not related to the query. As described in greater detail below, by focusing on the relevant information, the meta-adapters may generate robust feature representations that are less susceptible to noise and variations in the input data. The attention mechanism may help meta-adapters 222 to effectively leverage the information from the textual descriptions, leading to improved few-shot performance,

A learnable gating block may be a neural network component that may allow meta-adapters 222 to adaptively control the contribution of different input sources. In the context of the meta-adapters 222, the learnable gating block may be used to balance the influence of textual embeddings (T) and aggregated support embeddings (S). Advantageously, the learnable gating block may take as input the textual embedding (T) and the aggregated support embedding (S). A learnable weight matrix (W_{g}) and bias (b_{g}) may be used to compute a gate value (Gᵢ) for each element of the input.

In an aspect, the meta-adapters 222 may pass the gate value through a sigmoid activation function (σ) to produce a value between 0 and 1. Furthermore, meta-adapters 222 may use the gate value to weight the corresponding element of the textual and support embeddings. In an aspect, the output of the gating block may be the weighted sum of the textual and support embeddings. For example, a learnable gating block of the meta-adapters 222 may be represented mathematically by the following formula (1):

$${G}_{i} = σ ( {W}_{g} [ {T}_{i} ; {S}_{i} ] + {b}_{g} ) \qquad ( 1 )$$

The gating block may allow meta-adapters 222 to dynamically adjust the contribution of textual and support embeddings (e.g., semantic embeddings 314 and textual description embeddings 320) based on the specific task and input data. By intelligently combining information from different sources, the gating block may lead to improved performance on few-shot learning tasks.

Gated attention may be a mechanism that allows meta-adapters 222 to selectively focus on relevant information from different input sources. In the context of the meta-adapter modules, the gated attention may be used to refine the semantic embeddings 314 extracted from camera image data 310 and LiDAR point cloud data 308 by incorporating contextual information from textual description embeddings 320.

The attention mechanism may calculate the similarity between the query (textual description embedding 320) and key (semantic embedding 314) to determine the relevance of each feature. The attention weights may be used to weight the value (semantic embeddings 314) to produce a context-aware representation. The gating block, as explained earlier, may control the influence of the attention-weighted features and the original semantic features.

In accordance with the techniques of the present disclosure, the gating block may allow meta-adapters 222 to dynamically adjust the balance between the attention-weighted features and the original semantic features based on the specific task and input data. The final embedding (e.g., refined semantic embeddings 316A and 316B) may be a weighted sum of the attention-weighted features and the original semantic features, where the weights may be determined by the gating block. The attention weighted features may be represented by the following formula (2):

$$Attention ( Q , K , V ) = softmax ( \frac{Q {K}^{T}}{\sqrt{{d}_{k}}} ) V \qquad ( 2 )$$

The refined semantic embeddings 316A and 316B may be represented by the following formula (3):

$$A = G ∘ Attention ( Q , K , V ) + ( 1 - G ) ∘ V \qquad ( 3 )$$

By incorporating textual information, meta-adapters 222 may refine the semantic features to better capture the context of the scene, including the presence of protrusions. In the example of the framework illustrated in FIG. 3, the gated attention mechanism may allow meta-adapters 222 to focus on the most relevant information (e.g., protrusion information), leading to improved performance on few-shot learning tasks.

FIG. 4 is a block diagram illustrating an inference phase of the protrusion detection framework of the vehicle assistance system, in accordance with the techniques of this disclosure. For example, FIG. 4 illustrates a robust 3D scene understanding and protrusion detection pipeline that may accurately identify and describe objects in a scene surrounding the vehicle assistance system.

To achieve this, ML system 216 may leverage the power of meta-learning, specifically, to adapt ML system 216 to new and unseen scenarios with limited data. In an aspect, camera Bird's Eye View (BEV) features 402A may be extracted from camera image data 310. In an aspect, LiDAR BEV features 402B may comprise BEV features extracted from LiDAR point cloud data 308. In an aspect, camera semantic features (e.g., camera semantic embeddings 314A) (S_{camera}) may comprise semantic features extracted from camera image data 310 using semantic camera feature encoder 218A. Similarly, LiDAR semantic features (e.g., camera semantic embeddings 314B) (S_{LiDAR}) may comprise semantic features extracted from LiDAR point cloud data 308 using semantic LiDAR feature encoder 218B. The camera meta-adapter 222A and LiDAR meta-adapter 222B may be trained using few-shot learning techniques where these adapters may learn to adapt to new tasks with limited data. In an aspect, camera meta-adapter 222A and LiDAR meta-adapter 222B may be learnable modules that may quickly adapt the semantic features to new scenarios.

FIG. 4 illustrates that the meta-adapters 222 may help in reweighting and refining the semantic embeddings 314, resulting in more accurate and informative representations. More specifically, the learned meta-adapters 222 for LiDAR and camera data may be used to reweight or refine the semantic embeddings S_{camera} and S_{LidAR}. This reweighting/refining process may generate refined semantic embeddings 404A and 404B, which may be referred to hereinafter as A_{camera} and A_{LidAR}. As noted above, ML system 216 may extract F_{Camera}, F_{LiDAR}, S_{camera}, and S_{LidAR} from the input data (e.g., camera image data 310 and LiDAR point cloud data 308). ML system 216 may apply the learned meta-adapters 222 to S_{camera} and S_{LidAR} to obtain refined semantic embeddings 404, A_{camera} and A_{LidAR}. ML system 216 may fuse A_{camera}, A_{LidAR}, F_{Camera}, and F_{LiDAR} using the described techniques (e.g., attention mechanisms) to generate a comprehensive scene representation. In an aspect, ML system 216 may utilize the fused features for object detection, segmentation, or other 3D scene understanding tasks. The meta-learning framework may enable ML system 216 to adapt quickly to new and unseen scenarios, improving generalization capabilities. By leveraging both camera image data 310 and LiDAR point cloud data 308, ML system 216 may become more robust to variations in weather, lighting, and object appearances.

In the context of the advanced 3D scene understanding, ML system 216 may add position embeddings 406 (PositionEncoding(P_{camera}) and PositionEncoding (P_{LiDAR})) to incorporate spatial information into the refined semantic features (A_{camera} and A_{LiDAR}). By adding position embeddings 406, the semantic descriptors may be aligned with the spatial coordinates of the BEV features 402 (F Camera and F_{LiDAR}). This alignment may provide for more effective fusion of semantic and geometric information. The inclusion of position information may enrich the semantic descriptors, allowing ML system 216 to better understand the spatial relationships between objects and their surroundings.

In an aspect, scene encoders 220 for each modality may comprise multi-head attention transformers. In an aspect, each scene encoder 220A and 220B may utilize a multi-head attention mechanism to effectively fuse the aligned semantic descriptors (A′_{Camera} and A′_{LiDAR}) with the corresponding BEV features (F_{Camera} and F_{LiDAR}). To accomplish the process illustrated in FIG. 4, the multi-head attention mechanism may operate with multiple attention heads in parallel.

In one example, each attention head may focus on different subspaces of the input features, capturing diverse relationships and interactions between objects and their surroundings. The attention mechanism may allow ML system 216 to attend to information from different positions in the scene, enabling ML system 216 to capture spatial dependencies and contextual information. Advantageously, the output of the corresponding scene encoders 220 may consist of encoded BEV descriptors for both camera and LiDAR modalities. These descriptors may contain rich information about objects and their relationships within the 3D scene, capturing both semantic and geometric cues.

Accordingly, by incorporating position embeddings 406 and utilizing a multi-head attention mechanism, ML system 216 may learn more informative and discriminative object representations. In an aspect, the fused features may provide a more comprehensive understanding of the 3D scene, enabling more accurate object detection, segmentation, and other downstream tasks. The multi-head attention mechanism may allow ML system 216 to adaptively focus on different aspects of the scene based on the specific task and the characteristics of the input data.

In the example illustrated in FIG. 4, BEV features 402 (F Camera and F_{LiDAR}) may act as the query, representing the spatial locations and geometric information in the scene. In an aspect, adapted semantic descriptors 408 (A′_{Camera} and A′_{LiDAR}) may act as the key, representing the semantic information of objects.

As a non-limiting example, the transformer models (e.g., camera scene encoders 220A and 220B) may be trained to return a value that maximizes the outer product of query and key inputs. In other words, the camera scene encoders 220A and 220B may learn to associate the correct semantic information (key) with the corresponding spatial locations (query). The training process may be designed to prioritize the association of specific object types with their corresponding semantic protrusions in the scene. This may better ensure that the transformer learns to accurately identify and locate objects with specific semantic characteristics. The BEV descriptor features from both camera and LiDAR modalities may be concatenated together. The concatenation 410 may create a richer and more comprehensive representation of the 3D scene, combining information from different sensor sources.

ML system 216 may pass the concatenated BEV features through 3DOD fusion decoder 224. In an aspect, the 3DOD fusion decoder 224 may comprise a transformer decoder. The 3DOD fusion decoder 224 may be configured to extract 3D scene understanding output, such as, but not limited to, object locations, dimensions, and semantic labels. In an aspect, the 3DOD fusion decoder 224 may be specifically designed to extract information about object protrusions in the 3D scene. Extracting information about object protrusions with the disclosed techniques may include identifying the extent and shape of objects in the 3D space. The transformer mechanism of the 3DOD fusion decoder 224 may effectively fuse semantic and geometric information by associating semantic descriptors with corresponding spatial locations in the scene. In an aspect, the training process may prioritize object type specific protrusions, enabling the 3DOD fusion decoder 224 to accurately identify and locate objects with specific semantic characteristics, such as protrusions.

Concatenating BEV features 402 from camera and LiDAR may improve the robustness and accuracy of the 3D scene understanding. In an aspect, the 3DOD fusion decoder 224 may extract 3D scene understanding output, including object protrusion information, from the fused information.

FIG. 5 illustrates results of the inference performed by the protrusion detection framework, in accordance with the techniques of this disclosure. In this example, in addition to detecting an object such as vehicle 502 represented by the bounding box 504, the 3D scene understanding output 412 may include protrusion information. More specifically, the protrusion information may include specific characteristics about bicycles 506 mounted on the vehicle 502.

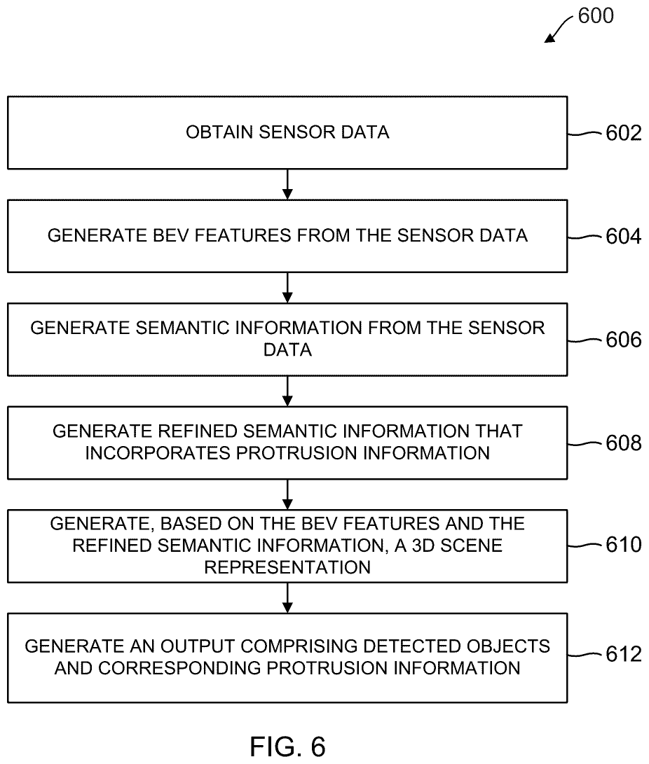

FIG. 6 is a flowchart illustrating an example method for protrusion detection by a vehicle assistance system, in accordance with the techniques of this disclosure. Although described with respect to computing system 200 (FIG. 2), it should be understood that other devices may be configured to perform a method similar to that of FIG. 6.

In this example, ML system 216 may initially obtain sensor data. In one example, ML system 216 may obtain multimodal sensor data from a plurality of sensors of vehicle 102 (602). The ML system 216 may generate one or more Bird's Eye View (BEV) features 402 from the sensor data (604). In some examples, ML system 216 may extract BEV features 402 from the multimodal sensor data. In an aspect, LiDAR BEV features 402B may comprise BEV features extracted from the LiDAR point cloud data 308 and camera BEV features 402A may comprise BEV features extracted from the camera image data 310, as described herein. Next, the ML system 216 may generate semantic information (e.g., semantic embeddings 314) from the sensor data (606). In an aspect, the semantic embeddings 314A and 314B may also be extracted from the camera image data 310 and LiDAR point cloud data 308, respectively.

The ML system 216 may apply a first machine learning model (e.g., meta-adapters 222 trained using few-shot learning techniques) to the semantic information (e.g., semantic embeddings 314) to generate refined semantic information (e.g., refined semantic embeddings) that incorporates protrusion information (608). In the example of the framework illustrated in FIG. 3, the gated attention mechanism may allow meta-adapters 222 to focus on the most relevant information (e.g., protrusion information), leading to improved performance on few-shot learning tasks. Next, the ML system 216 may generate, based on the one or more BEV features and the refined semantic information, a 3D scene representation of a scene surrounding vehicle 102 (610). In some examples, the ML system 216 may concatenate the plurality of BEV features 402 and the plurality of refined semantic embeddings 404 to generate the 3D scene representation of the scene surrounding the vehicle 102. As noted above, the concatenation 410 may create a richer and more comprehensive representation of the 3D scene, combining information from different sensor sources. In accordance with the techniques of the present disclosure, the ML system 216 may generate, based on the 3D scene representation, an output comprising one or more detected objects and protrusion information corresponding to the one or more detected objects (612). In an aspect, the 3DOD fusion decoder 224 may extract 3D scene understanding output, including object protrusion information, from the fused information (e.g., concatenated information). In other words, the ML system 216 may capture a wide range of information, from road geometry to object locations and object attributes. A rich feature space enables the ML system 216 to be applied to various downstream tasks of vehicle assistance system, such as, but not limited to, object detection, semantic segmentation, and motion prediction.

The following numbered clauses illustrate one or more aspects of the devices and techniques described in this disclosure.

Clause 1. A method for protrusion detection by a vehicle assistance system, the method comprising: obtaining sensor data; generating one or more Bird's Eye View (BEV) features from the sensor data; generating semantic information from the sensor data; applying a first machine learning model to the semantic information to generate refined semantic information that incorporates protrusion information; generating, based on the one or more BEV features and the refined semantic information, a 3D scene representation of a scene surrounding a vehicle; and generating, based on the 3D scene representation, an output comprising one or more detected objects and protrusion information corresponding to the one or more detected objects.

Clause 2. The method of clause 1, wherein the first machine learning model is trained using few-shot learning techniques.

Clause 3. The method of clause 2, wherein the first machine learning model employs a gated multi-head attention mechanism.

Clause 4. The method of clause 3, further comprising: training the first machine learning model using one or more support samples and textual descriptions corresponding to the one or more support samples, wherein the textual descriptions describe at least a protrusion type and context information.

Clause 5. The method of clause 4, wherein the gated multi-head attention mechanism receives textual description embeddings representing the textual descriptions as queries, and a plurality of semantic embeddings as keys and values for the gated multi-head attention mechanism.

Clause 6. The method of clause 4, wherein applying the first machine learning model further comprises: generating a gate value for each of the plurality of semantic embeddings using a learnable weight matrix and bias.

Clause 7. The method of any of clauses 1-6, wherein the refined semantic information comprises one or more refined semantic embeddings and wherein generating the 3D scene representation comprises: concatenating the one or more BEV features and the one or more refined semantic embeddings using position embeddings.

Clause 8. The method of any of clauses 1-6, wherein the refined semantic information comprises one or more refined semantic embeddings and wherein generating the 3D scene representation comprises: concatenating the one or more BEV features and the one or more refined semantic embeddings using a second machine learning model comprising a multi-head attention transformer.

Clause 9. The method of any of clauses 1-6, further comprising: operating a vehicle assistance system using the output.

Clause 10. A system for protrusion detection by a vehicle assistance system, the system comprising: a memory for storing sensor data; and processing circuitry in communication with the memory, wherein the processing circuitry is configured to: obtain the sensor data; generate one or more Bird's Eye View (BEV) features from the sensor data; generate semantic information from the sensor data; apply a first machine learning model to the semantic information to generate refined semantic information that incorporates protrusion information; generate, based on the one or more BEV features and the refined semantic information, a 3D scene representation of a scene surrounding a vehicle; and generate, based on the 3D scene representation, an output comprising one or more detected objects and protrusion information corresponding to the one or more detected objects.

Clause 11. The system of clause 10, wherein the first machine learning model is trained using few-shot learning techniques.

Clause 12. The system of clause 11, wherein the first machine learning model employs a gated multi-head attention mechanism.

Clause 13. The system of clause 12, wherein the processing circuitry is further configured to: train the first machine learning model using one or more support samples and textual descriptions corresponding to the one or more support samples, wherein the textual descriptions describe at least a protrusion type and context information.

Clause 14. The system of clause 13, wherein the gated multi-head attention mechanism receives textual description embeddings representing the textual descriptions as queries, and a plurality of semantic embeddings as keys and values for the gated multi-head attention mechanism.

Clause 15. The system of clause 14, wherein the processing circuitry configured to apply the first machine learning model is further configured to: generate a gate value for each of the plurality of semantic embeddings using a learnable weight matrix and bias.

Clause 16. The system of any of clauses 10-15, wherein the refined semantic information comprises one or more refined semantic embeddings and wherein the processing circuitry configured to generate the 3D scene representation is further configured to: concatenate the one or more BEV features and the one or more refined semantic embeddings using position embeddings.

Clause 17. The system of any of clauses 10-15, wherein the refined semantic information comprises one or more refined semantic embeddings and wherein the processing circuitry configured to generate the 3D scene representation is further configured to: concatenate the one or more BEV features and the one or more refined semantic embeddings using a second machine learning model comprising a multi-head attention transformer.

Clause 18. The system of any of clauses 10-15, wherein the processing circuitry is further configured to: operate a vehicle assistance system using the output.

Clause 19. Non-transitory computer-readable storage media having instructions encoded thereon, the instructions configured to cause processing circuitry to: obtain sensor data; generate one or more Bird's Eye View (BEV) features from the sensor data; generate semantic information from the sensor data; apply a first machine learning model to the semantic information to generate refined semantic information that incorporates protrusion information; generate, based on the one or more BEV features and the refined semantic information, a 3D scene representation of a scene surrounding a vehicle; and generate, based on the 3D scene representation, an output comprising one or more detected objects and protrusion information corresponding to the one or more detected objects.

Clause 20. The storage media of clause 19, wherein the first machine learning model is trained using few-shot learning techniques.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules or units configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for protrusion detection by a vehicle assistance system, the method comprising:
obtaining multimodal sensor data;
generating one or more Bird's Eye View (BEV) features from the sensor data;
generating semantic information from the sensor data;
applying a first machine learning model to the semantic information to generate refined semantic information that incorporates protrusion information;
generating, based on the one or more BEV features and the refined semantic information, a 3D scene representation of a scene surrounding a vehicle; and
generating, based on the 3D scene representation, an output comprising one or more detected objects and protrusion information corresponding to the one or more detected objects.

2. The method of claim 1, wherein the first machine learning model is trained using few-shot learning techniques.

3. The method of claim 2, wherein the first machine learning model employs a gated multi-head attention mechanism.

4. The method of claim 3, further comprising:
training the first machine learning model using one or more support samples and textual descriptions corresponding to the one or more support samples, wherein the textual descriptions describe at least a protrusion type and context information.

5. The method of claim 4, wherein the gated multi-head attention mechanism receives textual description embeddings representing the textual descriptions as queries, and a plurality of semantic embeddings as keys and values for the gated multi-head attention mechanism.

6. The method of claim 5, wherein applying the first machine learning model further comprises:
generating a gate value for each of the plurality of semantic embeddings using a learnable weight matrix and bias.

7. The method of claim 1, wherein the refined semantic information comprises one or more refined semantic embeddings and wherein generating the 3D scene representation comprises:
concatenating the one or more BEV features and the one or more refined semantic embeddings using position embeddings.

8. The method of claim 1, wherein the refined semantic information comprises one or more refined semantic embeddings and wherein generating the 3D scene representation comprises:
concatenating the one or more BEV features and the one or more refined semantic embeddings using a second machine learning model comprising a multi-head attention transformer.

9. The method of claim 1, further comprising:
operating a vehicle assistance system using the output.

10. A system for protrusion detection by a vehicle assistance system, the system comprising:
a memory for storing sensor data; and
processing circuitry in communication with the memory, wherein the processing circuitry is configured to:
obtain the sensor data;
generate one or more Bird's Eye View (BEV) features from the sensor data;
generate semantic information from the sensor data;
apply a first machine learning model to the semantic information to generate refined semantic information that incorporates protrusion information;
generate, based on the one or more BEV features and the refined semantic information, a 3D scene representation of a scene surrounding a vehicle; and
generate, based on the 3D scene representation, an output comprising one or more detected objects and protrusion information corresponding to the one or more detected objects.

11. The system of claim 10, wherein the first machine learning model is trained using few-shot learning techniques.

12. The system of claim 11, wherein the first machine learning model employs a gated multi-head attention mechanism.

13. The system of claim 12, wherein the processing circuitry is further configured to:
train the first machine learning model using one or more support samples and textual descriptions corresponding to the one or more support samples, wherein the textual descriptions describe at least a protrusion type and context information.

14. The system of claim 13, wherein the gated multi-head attention mechanism receives textual description embeddings representing the textual descriptions as queries, and a plurality of semantic embeddings as keys and values for the gated multi-head attention mechanism.

15. The system of claim 14, wherein the processing circuitry configured to apply the first machine learning model is further configured to:
generate a gate value for each of the plurality of semantic embeddings using a learnable weight matrix and bias.

16. The system of claim 10, wherein the refined semantic information comprises one or more refined semantic embeddings and wherein the processing circuitry configured to generate the 3D scene representation is further configured to:
concatenate the one or more BEV features and the one or more refined semantic embeddings using position embeddings.

17. The system of claim 10, wherein the refined semantic information comprises one or more refined semantic embeddings and wherein the processing circuitry configured to generate the 3D scene representation is further configured to:
concatenate the one or more BEV features and the one or more refined semantic embeddings using a second machine learning model comprising a multi-head attention transformer.

18. The system of claim 10, wherein the processing circuitry is further configured to:
operate a vehicle assistance system using the output.

19. Non-transitory computer-readable storage media having instructions encoded thereon, the instructions configured to cause processing circuitry to:
obtain sensor data;
generate one or more Bird's Eye View (BEV) features from the sensor data;
generate semantic information from the sensor data;
apply a first machine learning model to the semantic information to generate refined semantic information that incorporates protrusion information;
generate, based on the one or more BEV features and the refined semantic information, a 3D scene representation of a scene surrounding a vehicle; and
generate, based on the 3D scene representation, an output comprising one or more detected objects and protrusion information corresponding to the one or more detected objects.

20. The storage media of claim 19, wherein the first machine learning model is trained using few-shot learning techniques.
